(19) United States
(12) Patent Application Publication
(10) Pub. No.: US 2020/0200550 A1
(43) Pub. Date: Jun. 25, 2020

(54) SYSTEMS AND METHODS FOR OBTAINING TRANSPORTATION GUIDANCE

(71) Applicant: Ford Global Technologies, LLC, Dearborn, MI (US)

(72) Inventor: Abraham Mezaael, Southfield, MI (US)

(73) Assignee: Ford Global Technologies, LLC, Dearborn, MI (US)

(21) Appl. No.: 16/226,145

(22) Filed: Dec. 19, 2018

(51) Int. Cl. G01C 21/34; G06Q 30/02; G06Q 20/38

(52) U.S. Cl. CPC G01C 21/3438; G01C 21/3446; G06Q 50/30; G06Q 20/382; G06Q 30/0283

(57) ABSTRACT

Exemplary embodiments described in this disclosure generally pertain to transportation guidance systems and methods that assist a user of a user device to travel from a first location to a second location using various modes of transport such as trains, buses, cars, bicycles, and on foot. In an exemplary implementation, a transportation guidance request is received from the user by a computer of a transportation guidance system. The computer determines a proposed route between the first location and the second location and then evaluates various modes of transport for traversing the proposed route. The evaluation may be based on various factors such as pricing of various transport services, timing duration for various segments, and travel timing schedules. The computer then provides the user, a recommended transportation guidance based on the evaluation.

### FIELD OF THE DISCLOSURE

This disclosure generally relates to guidance services, and more particularly relates to systems and methods that assist a person in obtaining guidance for traveling from one location to another using various types of transportation.

### BACKGROUND

Transportation vehicles and services have evolved over time from a limited number of offerings in the past to a wide array of choices nowadays. With the advent of air travel, people nowadays travel to distant destinations inside a country as well as to faraway places located in foreign countries. Travel at these distant destinations and faraway places may be carried out by using various transportation services such as taxis, trains, and buses. However, it is often confusing and intimidating to use these transportation services due to various factors such as unfamiliarity with a language, unfamiliarity with local currencies, unfamiliarity with methods of payment, unfamiliarity with the geography of a place, unfamiliarity with local customs, and unfamiliarity with the availability of alternative modes of transport. It would therefore be helpful to have systems and methods that would offer transportation guidance to a traveler when faced with such situations.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows an exemplary transportation guidance system in accordance with an embodiment of the disclosure.

FIG. 2 shows some exemplary functional blocks of a computer system that may be used by a service provider to offer transportation guidance in accordance with an embodiment of the disclosure.

FIG. 3 shows some exemplary functional blocks of a device containing a transportation guidance system in accordance with an embodiment of the disclosure.

FIG. 4 shows some exemplary functional blocks of a computer system used by rail service operator in accordance with an embodiment of the disclosure.

FIG. 5 shows some exemplary functional blocks of a computer system used by a bus service operator in accordance with an embodiment of the disclosure.

FIG. 6 shows some exemplary functional blocks of a computer system used by a car rental service in accordance with an embodiment of the disclosure.

FIG. 7 shows some exemplary functional blocks of a computer system used by a financial service in accordance with an embodiment of the disclosure.

### DETAILED DESCRIPTION

The disclosure will be described more fully hereinafter with reference to the accompanying drawings, in which exemplary embodiments of the disclosure are shown. This disclosure may, however, be embodied in many different forms and should not be construed as limited to the exemplary embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described exemplary embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and terms are used herein solely for convenience, and such words and terms should be interpreted as referring to various objects and actions that are generally understood in various forms and equivalencies by persons of ordinary skill in the art. For example, a “ride request” is originated by a person who may be alternatively referred to herein as a “traveler” or as a “user” of a “device” or “user device.” Furthermore, it should be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

In terms of a general overview, certain embodiments described in this disclosure are directed to transportation guidance systems and methods that assist a user of a user device to travel from a first location to a second location using various modes of transport such as trains, buses, cars, bicycles, and on foot. In an exemplary implementation, a transportation guidance request is received from the user by a computer of a transportation guidance system. The computer determines a proposed route between the first location and the second location and then evaluates various modes of transport for traversing the proposed route. The evaluation may be based on various factors such as pricing of various transport services, timing duration for various segments, and travel timing schedules. The computer then offers to the user, a recommended transportation guidance based on the evaluation.

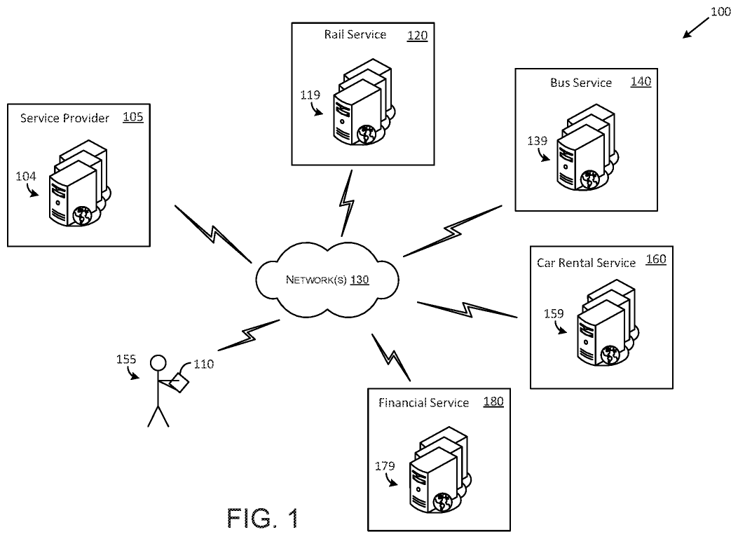

FIG. 1 shows an exemplary transportation guidance system 100 in accordance with an embodiment of the disclosure. The transportation guidance system 100 may include a service provider 105 that uses a service provider computer system 104 to execute various operations of a transportation guidance service. The service provider computer system 104 may communicate through the network 130 with various computer systems such as a rail services computer system 119 of a railway service 120, a bus services computer system 139 of a bus service 140, a car rental services computer system 159 of a car rental service 160, and a financial services computer system 179 of a financial service 180. The computer systems used by the providers and services may include various types of computers such as servers and clients, which may be communicatively coupled to each other via a network 130 such as a local area network (LAN) or a wide area network (WAN). The network 130 may include any one or a combination of various networks, such as a telephone network, a cellular network, a cable network, a wireless network, and/or private/public networks such as the Internet. In some instances, the network 130 may support communication technologies such as Bluetooth, cellular, near-field communication (NFC), Wi-Fi, and/or Wi-Fi direct.

The rail services computer system 119 may be configured to provide to the service provider computer system 104 and other computer systems, various types of information pertaining to rail services. For example, the rail services computer system 119 may provide a rail schedule that includes departure times, arrival times, and trip duration information of various trains that travel between various railway stations. The rail services computer system 119 may also provide information pertaining to fares, taxes, and fees associated with various train journeys, information pertaining to various destinations, information pertaining to facilities provided during the journeys (such as dining, stops, and pet accommodations), and legal requirements if any (such as passport, visa, and identification papers for travel between different countries).

The bus services computer system 139 may be configured to provide to the service provider computer system 104 and other computer systems, various types of information pertaining to bus services. For example, the bus services computer system 139 may provide a bus schedule that includes departure times, arrival times, and trip duration information of various buses offering travel between various bus depots. The bus services computer system 139 may also provide details pertaining to fares, taxes, and fees associated with various routes, details pertaining to various destinations, details pertaining to facilities provided during the bus trips (such as dining, stops, and pet accommodations), and legal requirements if any (such as passport, visa, and identification papers for travel between different countries).

The car rental services computer system 159 may be configured to provide to the service provider computer system 104 and other computer systems, various types of information pertaining to car rental services. For example, the car rental services computer system 159 may provide details pertaining to the various types of vehicles available for rent; rental charges, taxes, and fees associated with various types of cars; and various durations of rental. The car rental services computer system 159 may also provide details pertaining to various destinations, details pertaining to rental services, and legal requirements if any (such as passport, visa, and identification papers for travel between different countries).

The financial services computer system 179 may be configured to provide to the service provider computer system 104 and other computer systems, various types of information pertaining to financial services. For example, the financial services computer system 179 may provide various forms of payment for services (such as credit card, debit card, and electronic transactions) and details regarding various financial transactions carried out by the user 155, for example.

The rail services computer system 119, the bus services computer system 139, and the car rental services computer system 159 are only a few examples of various types of transportation services that may be included in the transportation guidance system 100 in accordance with the disclosure. Other services catering to various other forms of transport such as for example, a bicycle rental service, a golf cart rental service, and a Segway® rental service may be included in various embodiments of the disclosure.

A user 155 may use a user device 110 to communicate with the service provider 105 and/or the various services. The user device 110 may be any of various types of devices such as a smartphone, a tablet, or a laptop running a transportation guidance application. The transportation guidance application (not shown) may be provided by the service provider 105 or may be an application that is provided by a vendor and customized by the service provider 105. In one exemplary method of obtaining transportation guidance from the service provider 105, the user 155 transmits a transportation guidance request through the network 130, to the service provider computer system 104 of the service provider 105. The request may be made in one or more of various ways such as in the form of a telephone call, an email, a text message, or an entry in a website of the service provider 105. The request may provide various types of information such as a name of a destination that the user 155 wishes to travel to, a type of transport preferred (for example, a train ride), a type of transport that is to be avoided (for example, a rental car), a time for starting travel (such as a date and hour), an expenditure limit (for example, no more than $50), and personal preferences (such as type of meals desired, type of companion animal, and seating preference).

Upon receiving the transportation guidance request, the service provider computer system 104 may determine a proposed route for the user 155 to travel to the destination. This operation may involve various actions performed by the service provider computer system 104, such as accessing map information and routing information through the network 130, using a Global Positioning System (GPS) receiver located in the service provider computer system 104, obtaining GPS information through the network 130 from a GPS source, and/or communicating with the user device 110. Such information may be used for example to determine a current location of the user 155, to determine GPS coordinates of the destination, and/or to determine GPS coordinates of one or more locations enroute to the destination. The proposed route may also be determined by the service provider computer system 104 based on other factors such as the presence of bus stations, railway stations, and airports, which would indicate that various forms of transport may be available for use to reach the destination.

The service provider computer system 104 may then execute an evaluation procedure to evaluate each of one or more modes of transport for traversing the proposed route between a current location of the user 155 and the desired destination. The evaluation may be carried out by accessing one or more computer systems such as the rail services computer system 119, the bus services computer system 139, and/or the car rental services computer system 159, to obtain information pertaining to traversing the proposed route. For example, the proposed route may involve rail travel in a first segment of the proposed route and the information obtained from the rail services computer system 119 by the service provider computer system 104, may include ticket pricing information and trip timing information (schedule, duration, etc.) of one or more trains. The proposed route may also include a second segment that entails the user 155 walking from one location to another, such as from a railway station to a bus depot. There is no pricing involved in this second segment. However, timing information associated with this second segment is evaluated by the service provider computer system 104 for evaluating timing parameters that contribute to an overall time of travel to the destination.

The service provider computer system 104 may then generate an advisory incorporating some or all of the gathered information (timing, prices, duration, schedule etc.) that is associated with proposed route. The advisory may be transmitted to the user device 110 in the form of recommended transportation guidance to the user 155. The transportation guidance application provided in the device 110 may cooperate with the service provider computer system 104 to carry out additional actions. Such actions may include displaying the recommended transportation guidance on a display of the user device 110. The user 155 may peruse the recommended transportation guidance and begin his/her journey to the destination at a start time that may be a part of the recommended transportation guidance. The service provider computer system 104 may cooperate with the user device 110 by using GPS tracking for example, to detect the user 155 starting his/her journey and also detect the time at which the journey has been started. If the user 155 has started his/her journey at a time that is different than the start time provided in the recommended transportation guidance, the service provider computer system 104 may dynamically update the transportation guidance application in the user device 110. The transportation guidance application may then display the updated transportation guidance on the display of the user device 110 and the user 155 may use the updated recommended transportation guidance to continue on his/her journey. The recommended transportation guidance may include voice prompts, voice guidance, text prompts, reminders, etc., to keep the user 155 informed of various aspects of the journey. For example, if the user 155 is behind schedule on a walking segment of the journey, the transportation guidance application in the user device 110 may provide a voice prompt urging the user 155 to speed up his/her walking pace so as to make it on time to catch a train at a railway station, for example.

In an exemplary implementation, the service provider computer system 104 may obtain traffic information periodically or on as-needed basis, from one or more sources such as a traffic management computer system (not shown). The traffic information may be used to modify the recommended transportation guidance if needed. For example, an accident on a roadway may have caused a traffic jam that results in a delay in a portion of a bus journey (before the user 155 reaches a bus depot to catch a bus for the bus journey, or during the bus journey when the user 155 is on the bus). The service provider computer system 104 may re-evaluate and modify the recommended transportation guidance in view of the delay. The modification of the recommended transportation guidance may include for example, a change in a mode of transport, a change in timing, and/or a change in pricing. The transportation guidance application in the user device 110 may provide to the user 155 details pertaining to the modification of the recommended transportation guidance and various options that the user 155 may choose to make in view of the modification.

In another exemplary implementation, the service provider computer system 104 may also obtain traffic information that may be pertinent to certain special events. For example, some forms of public transport may be provided free of charge during certain events (a Thanksgiving Day parade, for example). The service provider computer system 104 obtains this information and conveys this information to the transportation guidance application provided in the user device 110. The user 155 may then opt to use the free transportation during the special event, thereby saving some money.

In yet another exemplary implementation, the service provider computer system 104 may cooperate with various entities (such as stores, restaurants, and commercial establishments) to provide advertisements, coupons, discounts, etc. that the user 155 may be able to use during various stages of his travel. For example, the user 155 may be provided a discount at a restaurant located close to a railway station and may be further provided with prompts and information that may entice the user 155 to eat at the restaurant after alighting from a train at the railway station.

The user device 110 used by the user 155 may include various components such as a GPS system, a voice synthesizer, a voice recognition system, and/or a scanner. The GPS system may be used for example, to provide location information to the service provider computer system 104. The voice synthesizer may be used to provide voice prompts in connection with the recommended transportation guidance. The voice recognition system may be used to allow the user 155 to input into the user device 110, for example, questions and commands pertaining to the recommended transportation guidance. The scanner may incorporate optical character recognition (OCR) to allow the user 155 to carry out various transactions such as obtaining pricing information and/or making payments. For example, the scanner may be used to scan a barcode such as a QR code, for obtaining ticket pricing information of a train ride and/or for making payment towards the train ride.

The transportation guidance application provided in the user device 110 is configured to detect various operations such as the user device 110 being used to make a payment. The user device 110 automatically transmits the payment information to the service provider computer system 104 and/or other computer systems such as the financial services computer system 179 for fulfilling the financial transaction. The automatic fulfillment of the financial transaction relieves the user 155 of various tasks such as carrying credit cards, carrying cash, carrying the appropriate type of currency, and calculating foreign exchange rates. In one exemplary embodiment, some aspects of the financial transactions carried out by the user 155 may be safeguarded by using block chain technologies. For example, certain details of the transaction may be made immutable by using block chain procedures, thereby providing security and confidence to the user 155.

In another exemplary embodiment, the financial services computer system 179 ensures that the user 155 is only charged for transactions that have been validated and completed. Incomplete or unfulfilled transactions are recognized and handled appropriately. For example, the user 155 may have purchased a train ticket but was unable to catch the train. This event may be detected by the service provider computer system 104 and/or the user device 110 (using GPS tracking and/or the scanner usage, for example) to confirm that the user 155 did not pass through an entry gate at the railway station and/or did not board the train. In such a situation, the train ticket fee may be refunded (minus cancellation charges if applicable), thereby freeing the user 155 of the burden of having to figure out the refund procedure and make a request for the refund.

In yet another exemplary embodiment, the transportation guidance application in the user device 110 may automatically detect that the user 155 is eligible for certain types of discounts (senior citizen discounts, for example) based on data such as age or date of birth, that is entered into the user device 110 by the user 155. These discounts are automatically applied to various financial transactions such as ticket purchases carried out by the user 155.

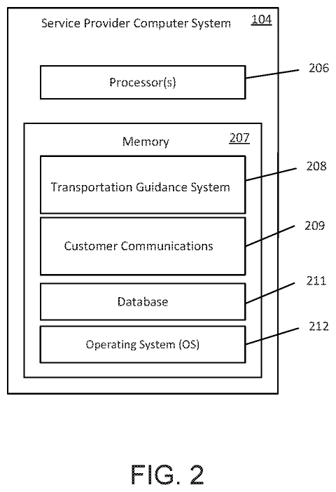

FIG. 2 shows some exemplary functional blocks of the service provider computer system 104 in accordance with an embodiment of the disclosure. The service provider computer system 104 may include several components such as a processor 206 and a memory 207. The memory 207, which is one example of a non-transitory computer-readable medium, may be used to store a transportation guidance system 208, a customer communications module 209, a database 211, and an operating system (OS) 212. Some operations associated with the transportation guidance system 208 have been described above, such as for example, the manner in which the transportation guidance system 208 cooperates with the user device 110 to provide a recommended transportation guidance to the user 155. The customer communications module 209 is configured for providing communications between the service provider 105 and various entities such as the user 155, the rail services computer system 119, the bus services computer system 139, the car rental services computer system 159, and the financial services computer system 179. The database 211 may be used to store information that may be utilized by the transportation guidance system 208 such as for example, information related to a guidance request made by the user 155. Such information may include a name of a destination that the user 155 wishes to travel to, a type of transport preferred (for example, a train ride), a type of transport that is to be avoided (for example, a rental car), a time for starting travel (such as a date and time), an expenditure limit (for example, no more than $50), and personal preferences (such as type of meals desired, type of companion animal, and seating preference).

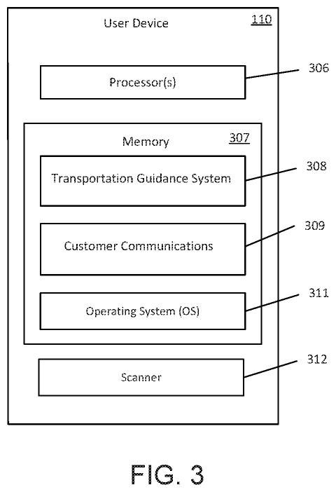

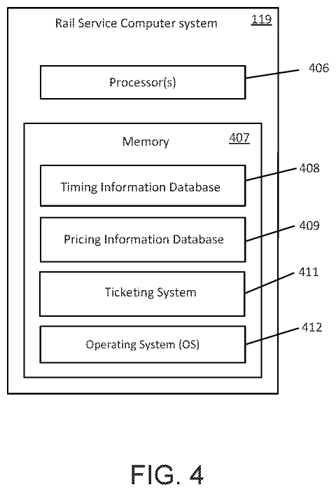

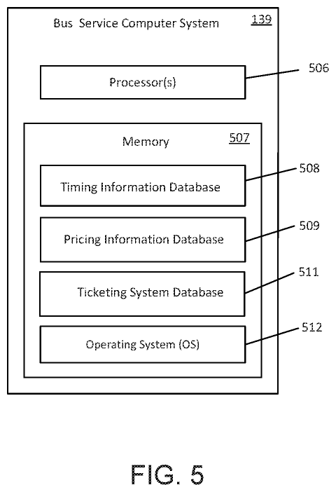

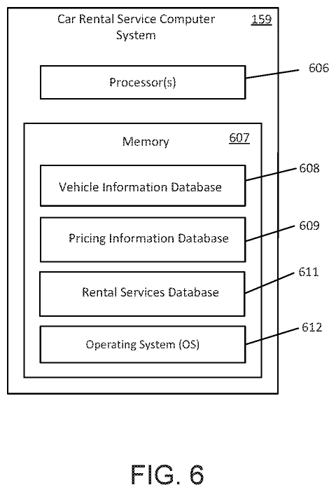

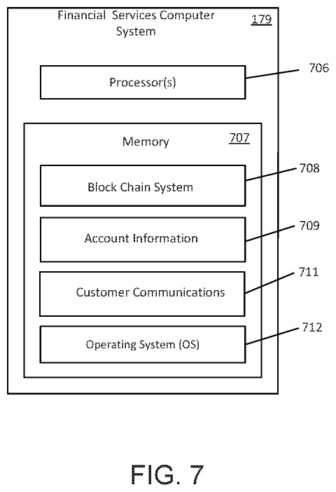

A memory device such as the memory 207, as well as other memory devices shown in various other figures (for example, a memory 307 shown in FIG. 3, a memory 407 shown in FIG. 4, a memory 507 shown in FIG. 5, a memory 607 shown in FIG. 6, and a memory 707 shown in FIG. 7) can include any one memory element or a combination of volatile memory elements (e.g., random-access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example, but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, because the program can be electronically captured, for instance, via optical scanning of the paper or other medium, then compiled, interpreted or otherwise processed in a suitable manner if necessary, and then stored in a computer memory.

FIG. 3 shows a few exemplary functional blocks of the user device 110 in accordance with an embodiment of the disclosure. The exemplary functional blocks may include several components such as a processor 306 and the memory 307. The memory 307, which constitutes a non-transitory computer-readable medium, may be used to store a transportation guidance system 308, a customer communications module 309, and an operating system (OS) 311. Some operations associated with the transportation guidance system 308 have been described above, such as for example, the manner in which the transportation guidance system 308 cooperates with the transportation guidance system 208 in the service provider computer system 104 to assist the service provider computer system 104 provide a recommended transportation guidance to the user 155. The customer communications module 309 is configured for providing communications between the user 155 and various entities such as the service provider 105, the rail services computer system 119, the bus services computer system 139, the car rental services computer system 159, and the financial services computer system 179. The user device 110 may further include a scanner 312 that may be used by the user 155 for various purposes such as to scan a barcode for obtaining pricing information or to capture an image of a ticket receipt.

FIG. 4 shows a few exemplary functional blocks of the rail service computer system 119 in accordance with an embodiment of the disclosure. The exemplary functional blocks may include several components such as a processor 406 and the memory 407. The memory 407, which constitutes a non-transitory computer-readable medium, may be used to store a ticketing system 411 and an operating system (OS) 412. The memory 407 may also be used to store information in the form of one or more databases such as for example, a timing information database 408 and a pricing information database 409. The rail service computer system 119 may use such databases for various purposes. For example, the rail service computer system 119 may respond to a communication from the service provider computer system 104 by accessing the timing information database 408 and/or the pricing information database 409 and providing information that may be used by the service provider computer system 104 to generate a recommended transportation guidance. The recommended transportation guidance may then be provided by the service provider computer system 104 to the user 155 as described above.

FIG. 5 shows a few exemplary functional blocks of the bus services computer system 139 in accordance with an embodiment of the disclosure. The exemplary functional blocks may include several components such as a processor 506 and the memory 507. The memory 507, which constitutes a non-transitory computer-readable medium, may be used to store a ticketing system 511 and an operating system (OS) 512. The memory 507 may also be used to store information in the form of one or more databases such as for example, a timing information database 508 and a pricing information database 509. The bus services computer system 139 may use such databases for various purposes. For example, the bus services computer system 139 may respond to a communication from the service provider computer system 104 by accessing the timing information database 508 and/or the pricing information database 509 and providing information that may be used by the service provider computer system 104 to generate a recommended transportation guidance. The recommended transportation guidance may then be provided by the service provider computer system 104 to the user 155 as described above.

FIG. 6 shows a few exemplary functional blocks of the car rental services computer system 159 in accordance with an embodiment of the disclosure. The exemplary functional blocks may include several components such as a processor 606 and the memory 607. The memory 607, which constitutes a non-transitory computer-readable medium, may be used to store an operating system (OS) 612 and information in the form of one or more databases such as for example, a vehicle information database 608, a pricing information database 609, and a rental services database 611. The car rental services computer system 159 may use such databases for various purposes. For example, the car rental services computer system 159 may respond to a communication from the service provider computer system 104 by accessing the vehicle information database 608 and/or the pricing information database 609 and providing information that may be used by the service provider computer system 104 to generate a recommended transportation guidance. As another example, the service provider computer system 104 may access the vehicle information database 608 to identify a vehicle such as a 4-door vehicle or a van that may be suitable for satisfying a request made by the user 155. The rental services database 611 may include for example, information such as insurance requirements, rental rates over various rental periods, pick-up and drop-off services, and rental agreements.

FIG. 7 shows a few exemplary functional blocks of the financial services computer system 179 in accordance with an embodiment of the disclosure. The exemplary functional blocks may include several components such as a processor 706 and the memory 707. The memory 707, which constitutes a non-transitory computer-readable medium, may be used to store an operating system (OS) 712 and information in the form of one or more databases such as for example, an accounts information database 709. The accounts information database 709 may include accounting details about various financial transactions carried out by the user 155. The memory 707 may also include a block chain system 708 and customer communications module 711. The block chain system 708 is configured to use block chain technology to provide security to financial transactions carried out by various entities such as the user 155 and the service provider computer system 104. The customer communications module 711 is configured for providing communications between the financial services computer system 179 and various entities such as the user 155, the service provider 105, the rail services computer system 119, the bus services computer system 139, and the car rental services computer system 159.

### Example Embodiments

In some instances, the following examples may be implemented together or separately by the systems and methods described herein.

Example 1 may include a method comprising: receiving, by at least one computer, a transportation guidance request from a user device for travelling from a first location to a second location; determining, by at least one processor in the computer, a proposed route between the first location and the second location; evaluating, by the at least one processor and based on at least one of a pricing information, a trip duration information, or a schedule information, each of one or more modes of transport for traversing the proposed route between the first location and the second location; and providing, by the at least one processor to the user device and based on the evaluation, a recommended transportation guidance.

Example 2 may include the method of example 1, wherein the recommended transportation guidance includes one or more of a walking segment, a driving segment, and a riding segment along the proposed route, and wherein the one or more modes of transport include one or more of an automobile, a train, and a two-wheeler.

Example 3 may include the method of example 2 and/or some other example herein, wherein the trip duration information includes one or more of a first timing duration associated with the walking segment, a second timing duration associated with the driving segment, and a third timing duration associated with the riding segment.

Example 4 may include the method of example 3 and/or some other example herein, further comprising: detecting, by the at least one processor, a trip start time of a user of the user device from the first location; detecting, by the at least one processor, a delay by the user when traversing a portion of the proposed route between the first location and the second location; and modifying one or more of the first timing duration, the second timing duration, or the third timing duration, based on detecting the delay.

Example 5 may include the method of example 4 and/or some other example herein, further comprising: providing a modified schedule to the user based on modifying the one or more of the first timing duration, the second timing duration, or the third timing duration.

Example 6 may include the method of example 1 and/or some other example herein, further comprising: receiving, by the at least one computer, information associated with one of a delay or a cancellation of at least one of the one or more modes of transport for traversing the proposed route between the first location and the second location; reevaluating, by the at least one processor, the at least one of the pricing information, the trip duration information, or the schedule information; determining, by the at least one processor, one or more alternative modes of transport to reach the second location; and providing to a user of the user device, a modified transportation guidance based on the reevaluating.

Example 7 may include the method of example 6 and/or some other example herein, wherein determining the one or more alternative modes of transport comprises determining an alternative route to reach the second location.

Example 8 may include the method of example 1 and/or some other example herein, further comprising: utilizing a blockchain payment system for executing automatic payments towards charges associated with at least the one or more modes of transport.

Example 9 may include a system comprising: at least one computer comprising: at least one memory that stores computer-executable instructions; and at least one processor configured to access the at least one memory and execute the computer-executable instructions to at least: receive a transportation guidance request for travelling from a first location to a second location; determine a proposed route between the first location and the second location; evaluate at least one of a pricing information, a trip duration information, or a schedule information, for each of one or more modes of transport for traversing the proposed route between the first location and the second location; and generate a recommended transportation guidance comprising the at least one of the pricing information, the trip duration information, or the schedule information, for each of the one or more modes of transport.

Example 10 may include the system of example 9, wherein the at least one computer is one of a first computer operated by a provider of a transportation guidance system or a second computer that is a part of a user device.

Example 11 may include the system of example 10 and/or some other example herein, wherein the second computer is located in one of a smartphone, a laptop computer, or a tablet, and wherein the recommended transportation guidance is displayed on a graphical user interface of an application executed in the one of the smartphone, the laptop computer, or the tablet.

Example 12 may include the system of example 11 and/or some other example herein, wherein the one of the smartphone, the laptop computer, or the tablet comprises: a global positioning system (GPS) configured to provide to the second computer, location information for at least one of determining the proposed route between the first location and the second location or detecting a current location of a user of the smartphone, the laptop computer, or the tablet.

Example 13 may include the system of example 9 and/or some other example herein, further comprising at least one database, the at least one computer configured to access the at least one database for obtaining the at least one of the pricing information, the trip duration information, or the schedule information.

Example 14 may include a method comprising: receiving, in at least one computer coupled to at least one memory, a transportation guidance request for travelling from an origination point to a destination point; receiving by the at least one computer, from at least one database, at least one of a pricing information, a trip duration information, or a schedule information for one or more modes of transport between the origination point and the destination point; and generating a recommended transportation guidance comprising the at least one of the pricing information, the trip duration information, or the schedule information.

Example 15 may include the method of example 14, wherein the one or more modes of transport include at least one of an automobile, a train, or a two-wheeler.

Example 16 may include the method of example 15 and/or some other example herein, wherein the pricing information comprises at least one of an automobile rental fee for the automobile, a two-wheeler rental fee for the two-wheeler, or a ticket price for the train.

Example 17 may include the method of example 16 and/or some other example herein, further comprising: automatically executing, by the at least one computer, one or more payment procedures for paying the at least one of the automobile rental fee for the automobile, the two-wheeler rental fee for the two-wheeler, or the ticket price for the train.

Example 18 may include the method of example 17 and/or some other example herein, further comprising: executing the one or more payment procedures by using a blockchain payment system.

Example 19 may include the method of example 15 and/or some other example herein, wherein fetching by the at least one computer, from the at least one database, of the at least one of the pricing information, the trip duration information, or the schedule information comprises two or more fetching operations, and further comprising: detecting a modification in at least one of the pricing information, the trip duration information, or the schedule information after at least one of the two or more fetching operations; and generating a modified transportation guidance based on detecting the modification.

Example 20 may include the method of example 15 and/or some other example herein, further comprising: detecting one of a delay or a cancellation in at least one of the one or more modes of transport between the origination point and the destination point; and generating a modified transportation guidance based on detecting the one of the delay or the cancellation.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving, by at least one computer, a transportation guidance request from a user device for travelling from a first location to a second location;
determining, by at least one processor in the computer, a proposed route between the first location and the second location;
evaluating, by the at least one processor and based on at least one of a pricing information, a trip duration information, or a schedule information, each of one or more modes of transport for traversing the proposed route between the first location and the second location; and
providing, by the at least one processor to the user device and based on the evaluation, a recommended transportation guidance.

2. The method of claim 1, wherein the recommended transportation guidance includes one or more of a walking segment, a driving segment, and a riding segment along the proposed route, and wherein the one or more modes of transport include one or more of an automobile, a train, and a two-wheeler.

3. The method of claim 2, wherein the trip duration information includes one or more of a first timing duration associated with the walking segment, a second timing duration associated with the driving segment, and a third timing duration associated with the riding segment.

4. The method of claim 3, further comprising:
detecting, by the at least one processor, a trip start time of a user of the user device from the first location;
detecting, by the at least one processor, a delay by the user when traversing a portion of the proposed route between the first location and the second location; and
modifying one or more of the first timing duration, the second timing duration, or the third timing duration, based on detecting the delay.

5. The method of claim 4, further comprising:
providing a modified schedule to the user based on modifying the one or more of the first timing duration, the second timing duration, or the third timing duration.

6. The method of claim 1, further comprising:
receiving, by the at least one computer, information associated with one of a delay or a cancellation of at least one of the one or more modes of transport for traversing the proposed route between the first location and the second location;
reevaluating, by the at least one processor, the at least one of the pricing information, the trip duration information, or the schedule information;
determining, by the at least one processor, one or more alternative modes of transport to reach the second location; and
providing to a user of the user device, a modified transportation guidance based on the reevaluating.

7. The method of claim 6, wherein determining the one or more alternative modes of transport comprises determining an alternative route to reach the second location.

8. The method of claim 1, further comprising:
utilizing a blockchain payment system for executing automatic payments towards charges associated with at least the one or more modes of transport.

9. A system comprising:
at least one computer comprising:
at least one memory that stores computer-executable instructions; and
at least one processor configured to access the at least one memory and execute the computer-executable instructions to at least:
receive a transportation guidance request for travelling from a first location to a second location;
determine a proposed route between the first location and the second location;
evaluate at least one of a pricing information, a trip duration information, or a schedule information, for each of one or more modes of transport for traversing the proposed route between the first location and the second location; and
generate a recommended transportation guidance comprising the at least one of the pricing information, the trip duration information, or the schedule information, for each of the one or more modes of transport.

10. The system of claim 9, wherein the at least one computer is one of a first computer operated by a provider of a transportation guidance system or a second computer that is a part of a user device.

11. The system of claim 10, wherein the second computer is located in one of a smartphone, a laptop computer, or a tablet, and wherein the recommended transportation guidance is displayed on a graphical user interface of an application executed in the one of the smartphone, the laptop computer, or the tablet.

12. The system of claim 11, wherein the one of the smartphone, the laptop computer, or the tablet comprises:
a global positioning system (GPS) configured to provide to the second computer, location information for at least one of determining the proposed route between the first location and the second location or detecting a current location of a user of the smartphone, the laptop computer, or the tablet.

13. The system of claim 9, further comprising at least one database, the at least one computer configured to access the at least one database for obtaining the at least one of the pricing information, the trip duration information, or the schedule information.

14. A method comprising:
receiving, in at least one computer coupled to at least one memory, a transportation guidance request for travelling from an origination point to a destination point;
receiving by the at least one computer, from at least one database, at least one of a pricing information, a trip duration information, or a schedule information for one or more modes of transport between the origination point and the destination point; and
generating a recommended transportation guidance comprising the at least one of the pricing information, the trip duration information, or the schedule information.

15. The method of claim 14, wherein the one or more modes of transport include at least one of an automobile, a train, or a two-wheeler.

16. The method of claim 15, wherein the pricing information comprises at least one of an automobile rental fee for the automobile, a two-wheeler rental fee for the two-wheeler, or a ticket price for the train.

17. The method of claim 16, further comprising:
automatically executing, by the at least one computer, one or more payment procedures for paying the at least one of the automobile rental fee for the automobile, the two-wheeler rental fee for the two-wheeler, or the ticket price for the train.

18. The method of claim 17, further comprising:
executing the one or more payment procedures by using a blockchain payment system.

19. The method of claim 15, wherein fetching by the at least one computer, from the at least one database, of the at least one of the pricing information, the trip duration information, or the schedule information comprises two or more fetching operations, and further comprising:
detecting a modification in at least one of the pricing information, the trip duration information, or the schedule information after at least one of the two or more fetching operations; and
generating a modified transportation guidance based on detecting the modification.

20. The method of claim 15, further comprising:
detecting one of a delay or a cancellation in at least one of the one or more modes of transport between the origination point and the destination point; and
generating a modified transportation guidance based on detecting the one of the delay or the cancellation.
